(19) United States
(12) Patent Application Publication
(10) Pub. No.: US 2015/0363871 A1
(43) Pub. Date: Dec. 17, 2015

(54) ONLINE SHOPPING SYSTEM AND METHOD

(71) Applicant: Tomika Shawan Chappell, Decatur, GA (US)

(72) Inventor: Tomika Shawan Chappell, Decatur, GA (US)

(21) Appl. No.: 14/250,346

(22) Filed: Apr. 10, 2014

Related U.S. Application Data
(60) Provisional application No. 61/810,461, filed on Apr. 10, 2013.

(51) Int. Cl. G06Q 30/06; G06Q 10/10; G06Q 30/02; H04L 12/58

(52) U.S. Cl. CPC G06Q 30/0641; H04L 51/12; G06Q 10/107; G06Q 30/0613; G06Q 30/0283

(57) ABSTRACT

An online shopping system and method is provided. The present invention includes a software that produces a request box for a consumer. The consumer types a request for a good and/or service within the request box. A third party receives the request and coordinates the retrieval of the goods and services. For example, the third party may contact a second party to perform the goods and services for the consumer. The goods and services are then made available for the consumer.

### CROSS-REFERENCE TO RELATED APPLICATION

This application claims the benefit of priority of U.S. provisional application No. 61/810,461, filed Apr. 10, 2013, the contents of which are herein incorporated by reference.

### BACKGROUND OF THE INVENTION

The present invention relates to online shopping and, more particularly, to a system and method of ordering goods and services online.

Online shopping or e-shopping is a form of electronic commerce which allows consumers to directly buy goods or services from a seller over the Internet using a web browser. However, to purchase a service or product, the buyer must find the vendor and then directly purchase from the vendor. Further, some of the products or services that are available do not meet a user's individual needs or specifications. For example, the product or service desired or needed may not exist or finding the product or service would take a lot of time and effort.

As can be seen, there is a need for an improved system and method for ordering goods and services online.

### SUMMARY OF THE INVENTION

In one aspect of the present invention, a system for ordering at least one of goods and services, comprises: a computer having a user interface; and a program product comprising machine-readable program code for causing, when executed, the computer to perform the following process steps: producing a request box for typing a request within; prompting a first party to input a message request within the request box, wherein the message request comprises at least one of a good and a service; receiving the message request from the first party of the at least one of the good and the service; and sending the message request to a second party, wherein the second party provides the at least one good and service to the first party.

These and other features, aspects and advantages of the present invention will become better understood with reference to the following drawings, description and claims.

### BRIEF DESCRIPTION OF THE DRAWINGS

FIG. 1 is a flow chart of an embodiment of the present invention; and

FIG. 2 is a schematic view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an online shopping system and method. The present invention includes a software that produces a request box for a consumer. The consumer types a request for a good and/or service within the request box. A third party receives the request and coordinates the retrieval of the goods and services. For example, the third party may contact a second party to perform the goods and services for the consumer. The goods and services are then made available for the consumer.

The present invention provides a platform and service using the internet. The platform and service may be displayed via a website, mobile application, and/or other form of communication. The present invention may facilitate the creating or finding of a product or service in which a consumer requests. The present invention provides a central location to request any product or service needed, thereby providing an efficient and convenient service for shopping. Requests may be made from anywhere in the world and delivered to anywhere in the world. The present invention may make any and everything available to any and everyone just by typing. Services may be discrete, anonymous, exclusive, confidential, and even expedited. The present invention allows the internet to function on an even more advanced level of convenience.

In certain embodiments, the present invention solves consumer dilemmas by allowing the consumer to order anything through a single medium. In certain embodiments, the consumer may set their own price and free shipping may be provided. The present invention eliminates the need to research because a third party may research for what the consumer desires, as opposed to the consumer searching for a specific product or service.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

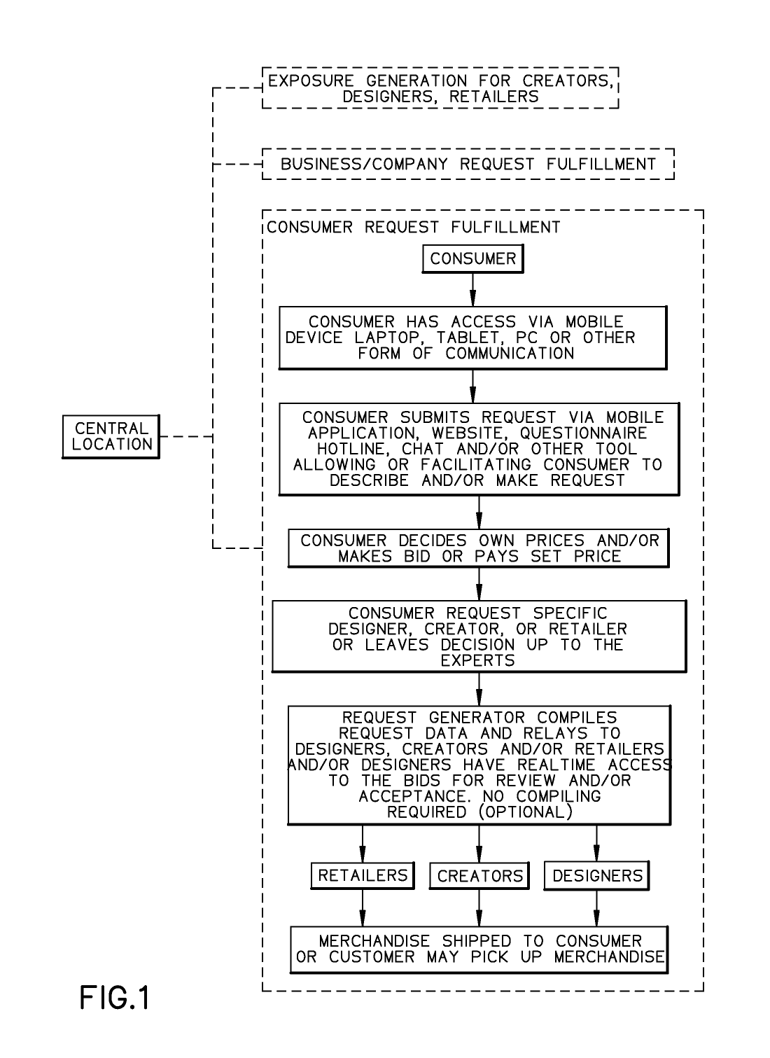

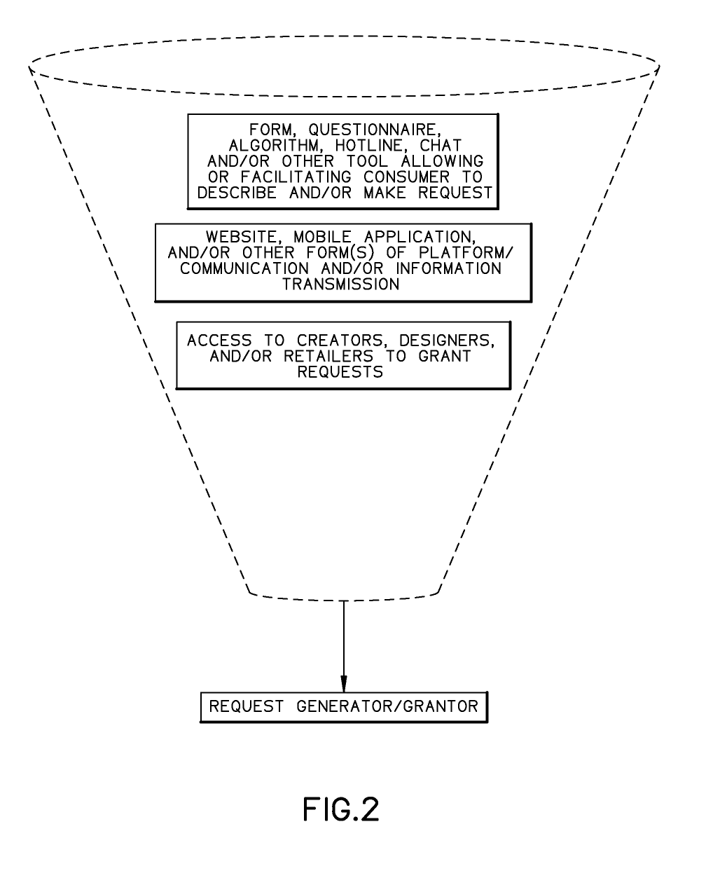

Referring to FIGS. 1 and 2, the present invention may include a consumer submitting a request for at least one of a good and service. The consumer may be an individual or business. A program product may cause a computer to perform steps in order for the consumer to request the goods and services. In certain embodiments, a request box may be produced with a cursor for typing a request within the request box. The request box may be produced on any computer, such as a laptop, tablet, personal computer, or other form of communication. A first party, i.e. the consumer, may input a message request within the request box. The request box may be in the form of a mobile application, website, a questionnaire, a hotline, a chat and/or other tool allowing the consumer to describe or make the request.

The message request includes a message that is created by the first party to request the goods and services. A message request may be a request that is either typed into the request box or voice recorded into the request box. Files, pictures, or other form of visual, auditory, or multisensory example may be uploaded to demonstrate product or service requested. The message request is then sent to other parties in order to provide the goods and services to the first party.

In certain embodiments, a second party and/or a third party may receive the message request from the consumer. If the message request is sent directly to the second party, the second party may produce the goods and services and provide them to the first party. For example, the second party may make a desired item and then mail the item to the first party or consumer. The second party may include at least one of a retailer, a creator, and a designer, depending upon the goods and services ordered.

In certain embodiments, the message request may be received by a third party. The third party may sort and compile the message request within a database based on a category of the message request. For example, the message request may be a request for a clothing item which would be sorted with the other requests for clothing items. The third party may then send the message request to a designated second party based on the category of the message request. The second party may then either produce or perform the goods and services, which may then be available or sent to the consumer.

In certain embodiments, the third party may provide a list of a plurality of second parties to the first party based on the category of the message request and thereby allowing the first party to select at least one of the plurality of second parties. Alternatively, the first party may elect that the third party determine which second party would be best to produce or perform the goods and services.

In certain embodiments, the price of the goods and service may be presented to the consumer once the message request has been entered. The price of the goods and services may be presented to the first party by either the second party or the third party. However, in certain embodiments, the consumer may submit a requested price for the goods and services ordered. In such embodiments, the second or third party may either accept the requested price or produce a counter price for the consumer to accept or decline.

As mentioned above, the present invention may facilitate the user picking their own price, free shipping, free inspirational letters, service fee, ability for the consumer to pick their own designer or have the third party pick the designer for them, the ability of the designers to bid or volunteer for a project, and the ability for the consumer to accept a bid conveniently. The present invention may also allow designers to gather and create, and thereby develop a name for themselves, develop their craft, and acquire exposure.

Any person may use the present invention to discretely request a product and/or service, which may be delivered to them. By following the above-listed steps anyone anywhere can order and receive anything, as long as a designer agrees to create it or it can be found for them. If there is a designer that accepts a project, it may be designed, including any tangible product, concept, software, hardware, and/or even intellectual property, a letter, poem, art, HTML code, original documents, original music, and/or drawings. Therefore, any goods and services may be created or found for the requester using the present invention.

In certain embodiments, companies may use the present invention to handle inventory. Hospitals and medical facilities may use the present invention to supply qualified staff. Families may use the present invention for extra assistance. Organizations and volunteers may use the present invention to achieve assistance and handle projects. Individuals may use the present invention to extend their expertise and network of support. Any entity may use the present invention as a back-office or supplier.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for ordering at least one of goods and services, comprising:
a computer having a user interface; and
a program product comprising machine-readable program code for causing, when executed, the computer to perform the following process steps:
producing a request box for entering a message request within;
prompting a first party to enter the message request within the request box, wherein the message request comprises at least one of a good and a service;
receiving the message request from the first party of the at least one of the good and the service; and
sending the message request to a second party, wherein the second party provides the at least one good and service.

2. The system of claim 1, wherein the computer further performs the step of: sending the message request to a third party, wherein the third party comprises a database for compiling and sorting the message request based on a category of the message request.

3. The system of claim 2, wherein the computer further performs the step of: sending the message request to a designated second party based on the category of the message request.

4. The system of claim 1, wherein the second party comprises at least one of a retailer, a creator, and a designer.

5. The system of claim 4, wherein the first party is a consumer.

6. The system of claim 2, wherein the computer further performs the step of: producing a plurality of second parties to the first party based on the category of the message request; and prompting the first party to select at least one of the plurality of second parties.

7. The system of claim 6, wherein the computer further performs the step of: prompting the first party to select between at least one of the plurality of second parties and a suggested second party, wherein the suggested second party is selected by the third party.

8. The system of claim 1, wherein the computer further performs the step of: prompting the first party to input a requested price to pay for the at least of the good and the service or accept a set price sent to the first party by at least one of the second party and the third party.

9. The system of claim 8, wherein the computer further performs the step of: receiving the requested price; and prompting at least one of the second party and the third party to either accept the requested price or input a counter offer.

10. The system of claim 1, wherein the request box is displayed on at least one of a mobile application, a website, a questionnaire, a hotline, and a chat box.
